(19) United States
(12) Patent Application Publication
(10) Pub. No.: US 2026/0299855 A1
(43) Pub. Date: Oct. 1, 2026

(54) FIRST COMMUNICATION DEVICE, NON-TRANSITORY COMPUTER-READABLE RECORDING MEDIUM STORING COMPUTER-READABLE INSTRUCTIONS FOR FIRST COMMUNICATION DEVICE, AND COMMUNICATION SYSTEM COMPRISING FIRST COMMUNICATION DEVICE

(71) Applicant: BROTHER KOGYO KABUSHIKI KAISHA, Nagoya (JP)

(72) Inventors: Akihito UNO, Iwakura (JP); Yutaka URAKAWA, Nagoya (JP)

(21) Appl. No.: 19/631,350

(22) Filed: Mar. 27, 2026

(30) Foreign Application Priority Data
Mar. 31, 2025 (JP) 2025-059547

(51) Int. Cl. G06F 3/12; H04L 9/40

(52) U.S. Cl. CPC G06F 3/1267; G06F 3/1222; G06F 3/1238; H04L 63/0807

(57) ABSTRACT

A first communication device may include: a memory configured to store job information in association with first user information corresponding to a first user; and a controller configured to: in a case where a first user authentication for the first user corresponding to the first user information is successful in a server on the Internet, receive a first token from the server, the first token being stored in the server in association with the first user information; send the server a first information request including the first token received from the server so as to receive the first user information stored in the server in association with the first token from the server; and execute a job following the job information due to the first user information received from the server matching the first user information stored in the memory in association with the job information.

### REFERENCE TO RELATED APPLICATIONS

This application claims priority to Japanese Patent Application No. 2025-059547 filed on March 31, 2025. The entire content of the priority application is incorporated herein by reference.

### BACKGROUND

An MFP (Multi-Function Peripheral) that stores a print job including a password is known. The MFP executes printing according to the print job when the password entered on a touch panel matches the password included in the print job.

The present specification provides a technique for securely executing a job.

### SUMMARY

A first communication device disclosed herein may include: a memory configured to store job information for causing the first communication device to execute a job in association with first user information corresponding to a first user; and a controller configured to: in a case where a first user authentication for the first user corresponding to the first user information is successful in a server on the Internet, receive a first token from the server, the first token being created in response to success of the first user authentication and being stored in the server in association with the first user information; send the server a first information request including the first token received from the server so as to receive the first user information stored in the server in association with the first token from the server as a response to the first information request; and execute the job following the job information stored in the memory due to the first user information received from the server matching the first user information stored in the memory in association with the job information.

According to the above configuration, a job according to the job information is executed in response to the success of the first user authentication on the server on the Internet. Thus, the job can be executed securely.

A non-transitory computer-readable recording medium storing computer-readable instructions for realizing the above-described first communication device is also novel and useful. A control method for the above-described communication device is also novel and useful.

A communication system disclosed herein may include: a first communication device; and a second communication device configured to communicate with the first communication device, wherein the second communication device is configured to send the first communication device a storing instruction for instructing to store job information for causing the first communication device to execute a job, the storing instruction including the job information and first user information corresponding to a first user, the first communication device may include a memory, the first communication device may be configured to: in response to receiving the storing instruction from the second communication device, store the job information included in the storing instruction in the memory in association with the first user information included in the storing instruction, in a case where a first user authentication for the first user corresponding to the first user information is successful in a server on the Internet, receive a first token from the server, the first token being created in response to success of the first user authentication and being stored in the server in association with the first user information; send the server a first information request including the first token received from the server so as to receive the first user information stored in the server in association with the first token from the server as a response to the first information request; and execute the job following the job information stored in the memory due to the first user information received from the server matching the first user information stored in the memory in association with the job information.

The above configuration can also allow a job to be securely executed.

### BRIEF DESCRIPTION OF DRAWINGS

FIG. 1 is a conceptual diagram of a communication system.

FIG. 2 is a block diagram of an MFP.

FIG. 3 is a block diagram of a user terminal.

FIG. 4 is a sequence diagram of a process for issuing a token.

FIG. 5 is a continuation of FIG. 2.

FIG. 6 is a sequence diagram of a print process.

FIG. 7 is a continuation of FIG. 6.

### DESCRIPTION

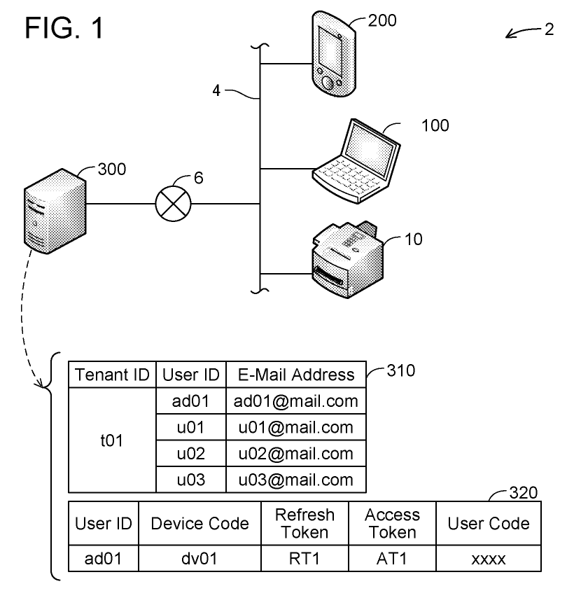

Configuration of Communication System 2; FIGS. 1 to 3

A communication system 2 comprises an MFP 10, an administrator terminal 100, a user terminal 200, and a server 300. The MFP 10 is a device with multiple functions including printing and scanning functions. “MFP” stands for a Multifunction Peripheral. The administrator terminal 100 and the user terminal 200 may be laptop PCs, desktop PCs, tablet terminals, smartphones, etc.

The MFP 10, the administrator terminal 100, and the user terminal 200 are used in a specific organization. The specific organization may be, for example, a corporation, an office, a department within a company, etc. The administrator terminal 100 is a terminal device used by an administrator belonging to the specific organization. The user terminal 200 is a terminal device used by a user who belongs to the specific organization and is managed by the administrator. Here, the specific organization has one or more users for one administrator. Therefore, there may be multiple user terminals 200 in the specific organization.

The MFP 10, the administrator terminal 100, and the user terminal 200 are connected to a LAN 4. “LAN” stands for Local Area Network. The LAN 4 may be wireless or wired. The administrator terminal 100 and the user terminal 200 are configured to communicate with the MFP 10 via the LAN 4.

The LAN 4 is connected to the Internet 6. The devices connected to the LAN 4, e.g., MFP 10, can communicate with the server 300 via the Internet 6 and LAN 4.

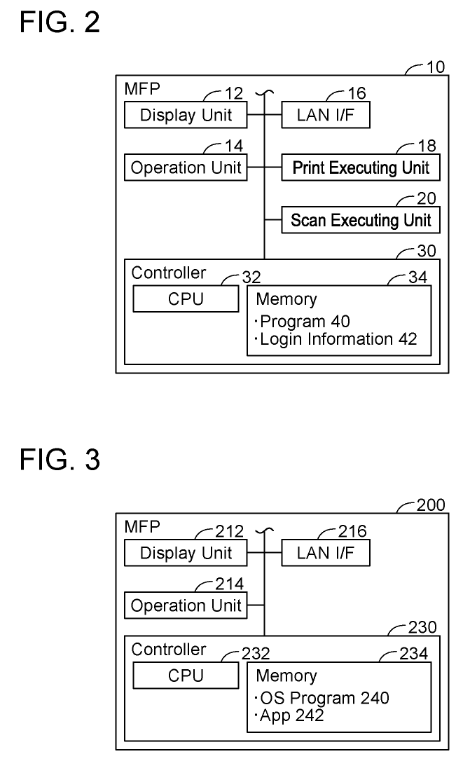

Configuration of MFP 10; FIG. 2

The MFP 10 comprises a display unit 12, an operation unit 14, a LAN interface 16, a print executing unit 18, a scan executing unit 20, and a controller 30. In the following, “interface” may be described as “I/F”.

The display unit 12 is a display or panel for showing various information. The panel may or may not be a touch panel. The panel may be, for example, an LCD panel or an OLED panel. The operation unit 14 is a user interface that allows the user to input various types of information to the MFP 10. The operation unit 14 comprises, for example, software key(s), i.e., a touch panel for displaying operation object(s), hardware key(s), or both. The hardware key(s) are, for example, button(s), switch(es), etc.

The LAN I/F 16 is an interface for communication via the LAN 4. The LAN I/F 16 is connected to the LAN 4. The print executing unit 18 is hardware configured to print on a print medium in accordance with print data. The print executing unit 18 is realized, for example, by an inkjet method and/or an electrophotographic method. The scan executing unit 20 is hardware configured to scan a document. The scan executing unit 20 comprises a scanner engine that has an image sensor such as a Charge-Coupled Device (CCD) or Contact Image Sensor (CIS).

The controller 30 comprises a CPU 32 and a memory 34. The memory 34 comprises a main storage and an auxiliary storage. Although this is an example, the main storage includes RAM and cache memory. Although this is an example, the auxiliary storage device may be ROM, flash memory, Solid State Drive (SSD), Hard Disk Drive (HDD), or a combination thereof. The CPU 32 performs various processes according to the program 40 loaded from the auxiliary storage to the main storage.

The MFP 10 has a server function that provides a setting screen for changing settings of the MFP 10. The memory 34 stores login information 42 for logging into a server function of the MFP 10. The login information 42 is, for example, a user name and password.

Configuration of Server 300; FIG. 1

The server 300 provides a service which manages accounts of users belonging to an organization. The service is, for example, Microsoft Entra ID (registered trademark). The server 300 stores an account table 310 and a token table 320.

The account table 310 manages information about users belonging to an organization. The account table 310 stores a tenant ID, a user ID, and an email addresses in association with each other. The tenant ID is an identifier that identifies the organization. The user ID is an identifier that identifies the user. The user ID is a so-called account name. Although not shown in the figures, each user ID is stored with a password in association therewith. For example, as shown in FIG. 1, one tenant ID “t01” is associated with four user IDs “ad01”, “u01”, “u02”, and “u03”. Here, the user ID “ad01” identifies the administrator who belongs to the specific organization identified by the tenant ID “t01”. Each of user IDs “u01”, “u02”, and “u03” identifies a user other than the administrator who belongs to the specific organization identified by the tenant ID “t01”. In the following, the user ID identifying the administrator will be described as an administrator ID. The user ID that identifies a user other than the administrator will be described as an individual user ID.

In this embodiment, the administrator ID “ad01” is stored in association with administrator privilege information that indicates privilege(s) of the administrator. The administrator privilege information indicates the privilege to access all email address(es) stored in association with the tenant ID “t01”. The individual user ID is also stored in association with individual privilege (i.e., individual authorization) information indicating privilege(s) of the user (i.e., authorization given to the user) identified by that individual user ID. The individual privilege information indicates the privilege to access the email address stored in association with the corresponding individual user ID. On the other hand, the individual privilege information does not indicate the privilege to access the email address(es) stored in association with other user ID(s). In a modification, the individual privilege information may indicate the privilege to access multiple email addresses. For example, the individual privilege information corresponding to the individual user ID “u01” may indicate the privilege to access not only the email address(es) stored in association with the individual user ID “u01” but also the email address(es) stored in association with another user ID “u02”.The token table 320 manages token(s). Token(s) are authentication information issued by the server 300. The token table 320 stores a user ID, a device code, a refresh token, an access token, and a user code in association with each other. The device code is a code assigned to a device such as the MFP 10. The user code is a code assigned to a user. The access token is authentication information for enabling the privilege indicated by the administrator privilege information or individual privilege information stored in association with the corresponding user ID. The access token is a token that has a predetermined expiration. The refresh token is a token for updating the access token. In a modification, the access token may not have an expiration date.

Configuration of User Terminal 200; FIG. 3

The user terminal 200 includes a display unit 212, an operation unit 214, a LAN I/F 216, and a controller 230. The LAN I/F 216 is connected to the LAN 4. The controller 230 includes a CPU 232 and a memory 234. The CPU 232 executes various processes in accordance with programs 240 and 242 loaded from the auxiliary storage into the main storage.

The OS program 240 controls the basic operations of the user terminal 200. The application 242 is an application program that creates print job information. The print job information is information for causing the MFP 10 to execute a print job. The print job information includes, for example, image data and print setting(s). The application 242 is, for example, provided by a vendor of the MFP 10. The application 242 is, for example, installed from a server on the Internet 6.

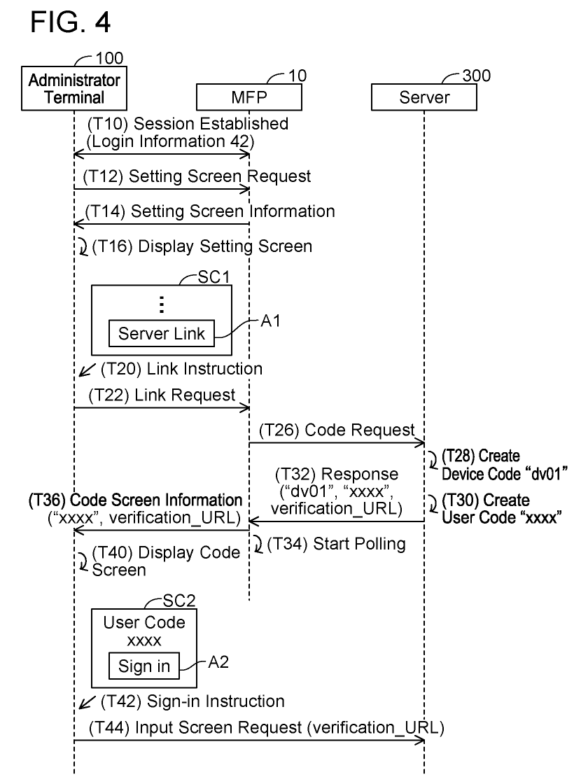

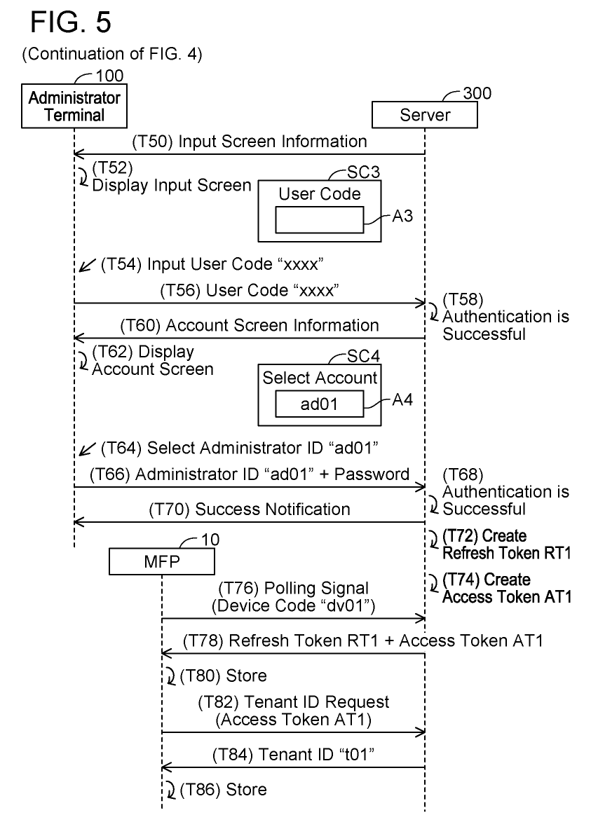

Process of Issuing Token; FIGS. 4 and 5

With reference to FIGS. 4 and 5, process of issuing a token will be described. In the following description, process executed by the MFP 10 is realized by the CPU 32 of the MFP 10, which operates according to the program 40. Communication between devices is executed via the LAN 4, the Internet 6, and the LAN I/F 16. In the following, when communication between devices is described, descriptions of the LAN 4, the Internet 6, and the LAN I/F 16 will be omitted.

In T10, the administrator terminal 100 logs into the server function of the MFP 10 using the login information 42. Due to this, a login session is established between the administrator terminal 100 and the MFP 10. In the following process, the login session is used for communication between the administrator terminal 100 and the MFP 10.

In T12, the administrator terminal 100 sends a setting screen request for requesting setting screen information to the MFP 10. The setting screen information is information corresponding to a setting screen SC1 for changing the settings of the MFP 10.

In T14, the administrator terminal 100 receives the setting screen information from the MFP 10 as a response to the setting screen request in T12. In T16, the administrator terminal 100 displays the setting screen SC1. The setting screen SC1 includes a plurality of icons corresponding to various settings of the MFP 10. The setting screen SC1 includes an icon A1 that receives an instruction to start a linkage with the server 300 from the user.

When the administrator terminal 100 detects selection of the icon A1 in the setting screen SC1 in T20, the administrator terminal 100 sends a link request to the MFP 10 in T22. The link request is a signal for requesting to start a link with the server 300.

When the MFP 10 receives the link request from the administrator terminal 100 in T22, the MFP 10 sends a code request to the server 300 in T26. The code request is a signal for requesting a device code and a user code. When the server 300 receives the code request from the MFP 10 in T26, the server 300 creates the device code “dv01” in T28. Furthermore, the server 300 creates a user code “xxxx” in T30. The server 300 stores the user code “xxxx” in the token table 320 in association with the device code “dv01”.

In T32, the server 300 sends a response to the code request to the MFP 10. The response includes the device code “dv01” created in T28, the user code “xxxx” created in T30, and a ‘verification_URL’. The ‘verification_URL’ is a URL for accessing input screen information corresponding to an input screen SC3 for inputting the user code. FIG. 5 shows an example of the input screen SC3.

When the MFP 10 receives the response from the server 300 in T32, the MFP 10 starts repeatedly sending polling signals to the server 300 in T34. The polling signal is a signal to confirm that a token has been issued. The polling signal includes the device code “dv01” received in T32.

In T36, the MFP 10 sends code screen information corresponding to a code screen SC2 which displays the user code to the administrator terminal 100. The code screen information includes the user code “xxxx” and the ‘verification_URL’.

When the administrator terminal 100 receives the code screen information from the MFP 10 in T36, the administrator terminal 100 displays the code screen SC2 in T40. The code screen SC2 includes a character string indicating the user code “xxxx” and an icon A2. The icon A2 is an icon that receives an instruction to sign in to the server 300 from the user.

When the administrator terminal 100 detects selection of the icon A2 in the code screen SC2 in T42, the administrator terminal 100 sends an input screen request to the server 300 in T44. The input screen request is a signal for requesting the input screen information and includes the ‘verification_URL’.

In T50 in FIG. 5, the administrator terminal 100 receives the input screen information as a response to the input screen request in T42. In T52, the administrator terminal 100 displays the input screen SC3. The input screen SC3 includes an input field A3 for inputting a user code.

In T54, the administrator terminal 100 detects the input of the user code “xxxx” in the input field A3. In T56, the administrator terminal 100 sends the user code “xxxx”, which had been inputted to the input field A3, to the server 300.

When the server 300 receives the user code “xxxx” from the administrator terminal 100 in T56, the server 300 authenticates the user code “xxxx” received from the administrator terminal 100. In this case, the user code “xxxx” received from the administrator terminal 100 matches the user code “xxxx” stored in the token table 320. Therefore, in T58, the authentication of the user code "xxxx" succeeds.

When the authentication of the user code “xxxx” succeeds, the server 300 sends account screen information to the administrator terminal 100 in T60. The account screen information corresponds to an account screen SC4 for selecting a target account name for which the token should be issued.

When the administrator terminal 100 receives the account screen information from the server 300 in T60, the administrator terminal 100 displays the account screen SC4 in T62. The account screen SC4 includes an icon A4 for selecting a target account name from the account name(s) stored in the administrator terminal 100. In this case, the administrator ID “ad01” is stored in the administrator terminal 100 as an account name. Due to this, the administrator ID “ad01” is displayed on the icon A4. If multiple account names are stored in the administrator terminal 100, multiple icons A4 are displayed on the account screen SC4. The account screen SC4 may also include an icon for creating a new account and an input field for entering a new account name and password. In this case, the administrator selects the icon A4 in the account screen SC4.

The administrator terminal 100 proceeds to T66 when detecting selection of the icon A4 in the account screen SC4 in T64. In T66, the administrator terminal 100 sends the administrator ID “ad01” corresponding to the icon A4 and the password to the server 300.

In T66, when the server 300 receives the administrator ID “ad01” and the password from the administrator terminal 100, the server 300 authenticates the administrator ID “ad01” and the password. In this case, the administrator ID “ad01” and the password are stored in the account table 310. Due to this, in T68, the authentication of the administrator ID “ad01” and password succeeds. The successfully authenticated administrator ID “ad01” is stored in the token table 320 in association with the user code “xxxx” and the device code “dv01”.

When the authentication of the administrator ID “ad01” and the password succeeds in T68, the server 300 proceeds to T70. In T70, the server 300 sends a success notification indicating that the authentication was successful to the administrator terminal 100. Further, in T72, the server 300 creates a refresh token RT1. In the subsequent T74, the server 300 creates an access token AT1 based on the refresh token RT1. The server 300 then stores the tokens RT1 and AT1 in the token table 320 in association with the administrator ID “ad01” and the device code “dv01”.

Between T36 in FIG. 2 and T74 in FIG. 3, the MFP 10 repeatedly sends polling signals including the device code “dv01” to the server 300. In T76, the server 300 receives a polling signal from the MFP 10 after the tokens RT1 and AT1 have been created. In T78, the server 300 sends the tokens RT1 and AT1, which are stored in association with the device code “dv01” included in the polling signal, to the MFP 10.

When the MFP 10 receives the tokens RT1 and AT1 from the server 300 in T78, the MFP 10 stores the tokens RT1 and AT1 in the memory 34 in T80.

In the following T82, the MFP 10 sends a tenant ID request for requesting a tenant ID to the server 300. The tenant ID request includes the access token AT1.

The server 300 receives the tenant ID request from the MFP 10 in T82 and proceeds to T84. The server 300 identifies the management identifier “ad01” stored in association with the access token AT1 within the tenant ID request from the token table 320 in T84. The server 300 then sends the tenant ID “t01” stored in the account table 310 in association with the identified management identifier “ad01” to the administrator terminal 100.

The MFP 10 receives the tenant ID “t01” from the server 300 in T84, and stores the tenant ID “t01” in the memory 34 in T86.

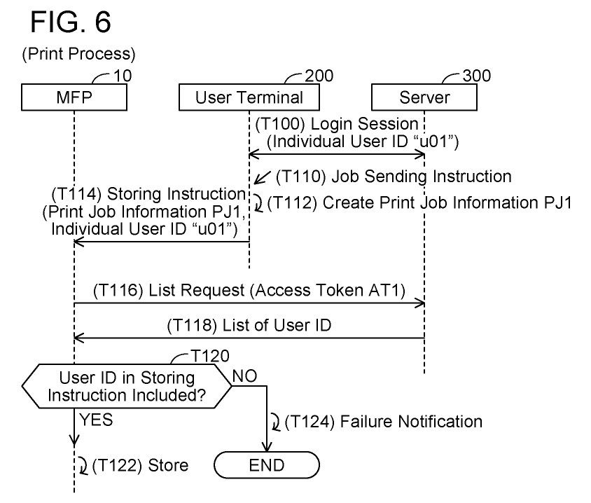

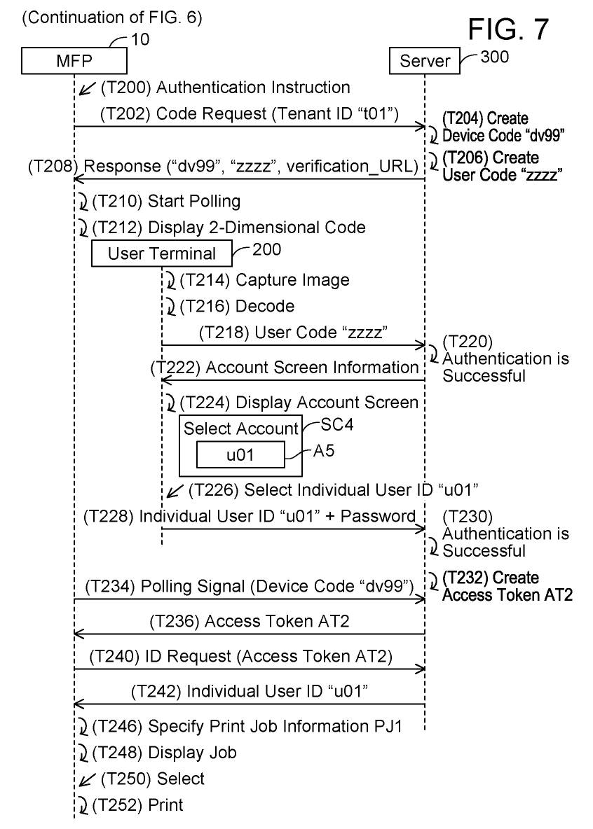

Print Process; FIGS. 6 and 7

The process shown in FIG. 6 is for sending the print job information to the MFP 10. The process shown in FIG. 6 can be executed after the processes shown in FIGS. 4 and 5.

The user terminal 200 establishes a login session using the individual user ID “u01” in T100. The timing at which the login session is established varies. For example, the login session may be established during activation performed when the user terminal 200 is started for the first time. In this case, the user terminal 200 may use the login session to obtain the individual user ID “u01” from the server 300. Alternatively, at other times, the login session may be established at any time the user inputs the individual user ID “u01” into the user terminal 200. Furthermore, the process of T100 need not be executed each time the process of FIG. 6 begins. For example, a situation may be expected where the process of FIG. 6 is executed consecutively multiple times. In this case, if the process of T100 has been executed during the first time of process of FIG. 6, the process of T100 may be omitted during the second and subsequent time of process of FIG. 6, as long as the session is not disconnected. Furthermore, in a modification, the process of T100 may not be executed. In this case, the user terminal 200 may store the individual user ID “u01”, which was previously used for a login session with the server 300, in the memory 234. Then, the user terminal 200 may send a storing instruction to the MFP 10 including the individual user ID “u01” from the memory 234, in T114 to be described below, without establishing a login session.

The user launches the application 242 in T110 and inputs a job sending instruction to the operation unit 214 of the user terminal 200. The job sending instruction is an instruction to send the print job information to the MFP 10. The processes of T112 and T114 to be described later are implemented by the application 242.

When detecting the input of the job sending instruction in T110, the user terminal 200 creates print job information PJ1 according to the job sending instruction in T112.

In T114, the user terminal 200 sends a storing instruction which instructs the MFP 10 to store the print job information to the MFP 10. The storing instruction includes the print job information PJ1 created in T112 and the individual user ID “u01” used in the login session in T100.

When the MFP 10 receives the storing instruction from the user terminal 200 in T114, the MFP 10 sends a list request to the server 300 in T116. The list request is a signal requesting a list of user ID(s) identifying user(s) belonging to a specific organization. The list request includes the access token AT1.

When the server 300 receives the list request from the user terminal 200 in T116, the server 300 proceeds to T118. In T118, the server 300 specifies the administrator ID “ad01” stored in association with the access token AT1 included in the list request. The server 300 identifies all individual user ID(s) stored in association with the tenant ID “t01” along with the specified administrator ID “ad01”. The server 300 then sends all the individual user ID(s) and administrator ID “ad01” to the MFP 10 as a list of user ID(s).

When the MFP 10 receives the list of user ID(s) from the server 300 in T118, the MFP 10 proceeds to T120. In T120, the MFP 10 determines whether the list of user ID(s) received in T118 includes the individual user ID “u01” included in the storing instruction in T114. The inclusion of the individual user ID “u01” in the list of user ID(s) means that the user corresponding to the individual user ID “u01” belongs to the specific organization. When the MFP 10 determines that the individual user ID “u01” within the storing instruction is included in the list of user ID(s) (YES in T120), the MFP 10 proceeds to T122.

In T122, the MFP 10 stores the print job information PJ1 in the storing instruction in T114 into the memory 34. Furthermore, when the MFP 10 determines that the list of user ID(s) does not include the individual user ID “u01” in the storing instruction (NO in T120), the MFP 10 proceeds to T124. In T124, the MFP 10 sends a failure notification indicating that the storing of the print job information has failed to the user terminal 200. This configuration can suppress print job information from a user not belonging to the specific organization from being stored in the MFP 10. It can also allow the user to be notified of the failure in storing the print job information.

Furthermore, the storing instruction in T114 includes the individual user ID “u01” used in the login session at the user terminal 200. The user corresponding to the individual user ID “u01” used in the login session is presumed to be the user who is operating the user terminal 200. According to the above configuration, the print job information PJ1 can be stored in the MFP 10 in association with the user operating the user terminal 200. In a modification, in T110, the user may input the individual user ID “u01” into the operation unit 14 in addition to the job sending instruction. The individual user ID “u01” input by the user may be included in the storing instruction.

The process in FIG. 7 is continuation from the process in FIG. 6. The user inputs an authentication instruction to the operation unit 14 of the MFP 10 in T200. The authentication instruction is an instruction to start authentication for the user who uses the print job information stored in the MFP 10.

When the MFP 10 detects the input of the authentication instruction in T200, the MFP 10 proceeds to T202. In T202, the MFP 10 sends a code request including the tenant ID “t01” stored in the memory 34 to the server 300. The code request in T202 is the same as the code request in T26 in FIG. 4, except that the code request in T202 includes the tenant ID “t01”.

The processes in T204 and T206 are the same as those of T28 and T30 of FIG. 4, except that the device code “dv99” and the user code “zzzz” are created. The processes of T208 and T210 are the same as the processes of T32 and T34 in FIG. 4, except that the device code “dv99” and the user code “zzzz” are used.

In the following T212, the MFP 10 displays a two-dimensional code on the display unit 12. The two-dimensional code is an image encoded with the ‘verification_URL’ and the user code “zzzz” received from the server 300.

In T214, the user operates the user terminal 200 to capture the two-dimensional code displayed in T212. Due to this, in T216, the user terminal 200 decodes the two-dimensional code and obtains the ‘verification_URL’ and the user code “zzzz”.

In T218, the user terminal 200 sends the user code “zzzz” to the server 300 using the ‘verification_URL’.

When the server 300 receives the user code “zzzz” from the user terminal 200 in T218, the server 300 authenticates the user code “zzzz” received from the user terminal 200. In this case, the user code “zzzz” received from the user terminal 200 matches the user code “zzzz” stored in the token table 320. Due to this, in T220, the authentication of the user code “zzzz” succeeds.

When the authentication of the user code “zzzz” succeeds, the server 300 sends the account screen information to the user terminal 200 in T222.

When the user terminal 200 receives the account screen information from the server 300 in T222, the user terminal 200 displays the account screen SC4 in T224. In this case, the individual user ID “u01” is stored in the user terminal 200 as an account name. The account screen SC4 includes an icon A5 on which the individual user ID “u01” is displayed.

When the user terminal 200 detects selection of the icon A5 in the account screen SC4 in T226, the user terminal 200 proceeds to T228. In T228, the user terminal 200 sends the individual user ID “u01” corresponding to the icon A5 and the password to the server 300.

When the server 300 receives the individual user ID “u01” and password from the user terminal 200 in T228, the server 300 authenticates the individual user ID “u01” and password. In this case, the individual user ID “u01” and password are successfully authenticated in T230. The individual user ID “u01” that has been successfully authenticated is stored in association with the device code “dv99” and stored in the token table 320. Next, the server 300 creates the access token AT2, and stores the access token AT2 in the token table 320 in association with the device code “dv99”.

In T234, the server 300 receives a polling signal from the MFP 10 after the access token AT2 has been created. In T236, the server 300 sends the access token AT2 stored in association with the device code “dv99” included in the polling signal to the MFP 10.

In the subsequent T240, the MFP 10 sends an ID request requesting a user ID to the server 300. The ID request includes the access token AT2.

When the server 300 receives the ID request from the user terminal 200 in T240, the server 300 proceeds to T242. In T242, the server 300 specifies the individual user ID “u01” stored in association with the access token AT2 within the ID request from the token table 320. Then, the server 300 sends the specified individual user ID “u01” to the user terminal 200.

When the MFP 10 receives the individual user ID “u01” from the server 300 in T242, the MFP 10 proceeds to T246. In T246, the MFP 10 specifies, from the memory 34, the print job information stored in association with the individual user ID matching the individual user ID “u01” received from the server 300. In this case, the print job information PJ1 is stored in the memory 34 in association with the individual user ID “u01” in T122 in FIG. 6. Due to this, in T246, the MFP 10 specifies the print job information PJ1 from the memory 34.

In T248, the MFP 10 displays a print job indicated by the print job information PJ1 specified in T246 on the display unit 12. If multiple pieces of print job information are stored in association with the individual user ID “u01” in the memory 34, the MFP 10 displays a list of print jobs indicated by the multiple pieces of print job information on the display unit 12.

When the MFP 10 detects that one of the jobs displayed on the display unit 12 has been selected in T250, the MFP 10 proceeds to T252. In T252, the MFP 10 executes the print job selected in T250. Specifically, the MFP 10 instructs the print executing unit 18 to print an image according to the print job information corresponding to the selected print job.

According to the configuration of this embodiment, when authentication of the individual user ID “u01” by the user terminal 200 succeeds, the MFP 10 receives the access token AT2 from the server 300 (T236 in FIG. 7). Using the access token AT2, the MFP 10 receives the individual user ID “u01” from the server 300 (T242). In this case, the individual user ID “u01” received from the server 300 matches the individual user ID “u01” stored in the memory 34 in association with the print job information PJ1. The MFP 10 executes the print job according to the print job information PJ1 stored in the memory 34 in association with the individual user ID “u01” (T252). Thus, upon successful authentication of the individual user ID “u01” on the server 300 on the Internet 6, the print job according to the print job information PJ1 is executed. The print job can be executed securely.

Furthermore, the authentication using the individual user ID shown in FIG. 7 is initiated by the code request including the tenant ID “t01” as a trigger. The tenant ID “t01” is obtained using the access token AT1 corresponding to the administrator ID “ad01” (T84 in FIG. 5). That is, the process in FIG. 7 is executed under the conditions of both the authentication using the administrator ID and the authentication using the individual user ID.

Furthermore, a situation where multiple pieces of the print job information are stored in association with the individual user ID “u01” in the memory 34 will be assumed. In this situation, the processes of T248 and T250 in FIG. 7 may not be executed, and all the print jobs corresponding to the multiple pieces of the print job information may be executed in T252. Since there is no need to select a print job, user convenience can be improved.

### Correspondence Relationships

The MFP 10, the display unit 12, and the memory 34 are examples of “first communication device,” “display unit,” and “memory,” respectively. The server 300 is an example of “server.” The individual user ID “u01” and the authentication of T230 in FIG. 7 are examples of “first user information” and “first user authentication,” respectively. The access token AT2 and the ID request of T240 are examples of “first token” and “first information request,” respectively. The user code “zzzz,” the device code “dv99,” and the polling signal of T210 are examples of “user code,” “device code,” and “signal,” respectively. The administrator ID “ad01” and the tenant ID “t01” are examples of “second user information” and “organization identifier,” respectively. The access token AT1 is an example of “second token.” The code request of T202 in FIG. 7 and the user terminal 200 are examples of “start Instruction” and “second communication device,” respectively. The list of T248 is an example of “list”. The list request of T116 and the failure notification of T124 in FIG. 6 are examples of “second information request” and “predetermined notification”, respectively. The communication system 2 is an example of “communication system”.

T236, T242, and T252 in FIG. 7 are respectively examples of processes realized by “receive a first token from the server”, “send the server a first information request including the first token received from the server so as to receive the first user information”, and “execute the job”. T114 and T122 in FIG. 6 are respectively examples of processes realized by “send the first communication device a storing instruction” and “store the job information”.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

### Modification 1

The storing instruction of T114 in FIG. 6 may include an email address corresponding to the individual user ID “u01” instead of the individual user ID “u01” itself. Furthermore, the MFP 10 may store the print job information PJ1 in the memory 34 in association with that email address. Additionally, in T242 of FIG. 7, the MFP 10 may receive the email address from the server 300 instead of the individual user ID “u01”. In the present modification, the email address is an example of “first user information”.

### Modification 2

The “first communication device” may not be limited to the MFP 10, but may also be a printer, a scanner, a facsimile machine, a terminal device, a sewing machine, etc. In other words, the “job” may not be limited to a print job, but may also be a scan job, a fax job, an embroidery job, job for creating other data, etc. That is, the “job” needs only to represent the content of a process to be executed by the “first communication device.” Furthermore, the “first communication device” may not be limited to the device described in each embodiment. The first communication device may be any device configured to obtain the content of the process to be executed by the first communication device from a device configured to communicate with the first communication device, and executing that process.

### Modification 3

The processes of T116 to T120 in FIG. 6 may not be executed, and the process of T122 may be executed. In this modification, “send the server a second information request” is omitted. Furthermore, in this modification, the processes shown in FIGS. 4 and 5 may not be executed. In this modification, the “second token” is omitted.

### Modification 4

The process of T124 in FIG. 6 may not be executed. In this modification, the “predetermined notification” is omitted.

### Modification 5

In the above embodiment, each process in FIGS. 4 through 7 is realized by the CPU 32 executing the program 40. Instead of these, any of the process may be realized by hardware such as logic circuitry.

What is claimed is:

1. A first communication device comprising:
a memory configured to store job information for causing the first communication device to execute a job in association with first user information corresponding to a first user; and
a controller configured to:
in a case where a first user authentication for the first user corresponding to the first user information is successful in a server on the Internet, receive a first token from the server, the first token being created in response to success of the first user authentication and being stored in the server in association with the first user information;
send the server a first information request including the first token received from the server so as to receive the first user information stored in the server in association with the first token from the server as a response to the first information request; and
execute the job following the job information stored in the memory due to the first user information received from the server matching the first user information stored in the memory in association with the job information.

2. The first communication device according to claim 1, wherein
an organization identifier is stored in the server, the organization identifier identifying an organization to which the first user and a second user corresponding to second user information different from the first user information belong, and
the controller is further configured to:
in a case where a second user authentication for the second user corresponding to the second user information is successful in the server before receiving the first token from the server, receive a second token different from the first token from the server, the second token being created in response to success of the second user authentication and being stored in the server in association with the second user information;
in response to receiving the second token from the server, send the server an identifier request for requesting the organization identifier, the identifier request including the second token;
receive the organization identifier stored in the server in association with the second token included in the identifier request from the server; and
send the server a start instruction for instructing to start the first user authentication, the start instruction including the organization identifier received from the server.

3. The first communication device according to claim 1, wherein
the controller is further configured to:
send the server a code request for requesting a user code so as to receive the user code from the server; and
output the user code received from the server, and
the user code outputted from the first communication device is obtained by a second communication device different from the first communication device,
the obtained user code and a first user identifier identifying the first user are sent to the server by the second communication device, and
the first user authentication includes:
the server authenticating the user code received from the second communication device, and
the server authenticating the first user identifier received from the second communication device.

4. The first communication device according to claim 3, wherein
the controller is further configured to:
receive a device code different from the user code from the server; and
start polling a signal including the device code in response to receiving the device code from the server,
the controller is configured to, in a case where the signal is received after the success of the first user authentication, receive the first token stored in the server in association with the device code included in the signal from the server as a response to the signal.

5. The first communication device according to claim 1, wherein
the first token has an expiration.

6. The first communication device according to claim 1, wherein
the job is a print job.

7. The first communication device according to claim 1, wherein
the memory stores the job information in association with the first user information,
the first communication device further comprises a display unit, and
the controller is further configured to:
cause the display unit to display a list of one or more jobs indicated by the job information stored in the memory in association with the first user information, and
the controller is configured to execute the job following the job information selected by the first user on the list.

8. The first communication device according to claim 1, wherein
the job information comprises two or more pieces of job information,
the memory is configured to store the two or more pieces of job information in association with the first user information, and
the controller is configured to execute all jobs following the two or more pieces of job information stored in the memory.

9. A communication system comprising:
a first communication device; and
a second communication device configured to communicate with the first communication device, wherein
the second communication device is configured to send the first communication device a storing instruction for instructing to store job information for causing the first communication device to execute a job, the storing instruction including the job information and first user information corresponding to a first user,
the first communication device comprises a memory,
the first communication device is configured to:
in response to receiving the storing instruction from the second communication device, store the job information included in the storing instruction in the memory in association with the first user information included in the storing instruction,
in a case where a first user authentication for the first user corresponding to the first user information is successful in a server on the Internet, receive a first token from the server, the first token being created in response to success of the first user authentication and being stored in the server in association with the first user information;
send the server a first information request including the first token received from the server so as to receive the first user information stored in the server in association with the first token from the server as a response to the first information request; and
execute the job following the job information stored in the memory due to the first user information received from the server matching the first user information stored in the memory in association with the job information.

10. The communication system according to claim 9, wherein
the second communication device is further configured to establish a login session for which the first user information is used with the server, and
the storing instruction includes the first user information used for the login session.

11. The communication system according to claim 9, wherein
a second token different from the first token is stored in the memory,
the first communication device is further configured to:
in response to receiving the storing instruction from the second communication device, send the server a second information request including the second token stored in the memory,
in a case where the first user information is received from the server as a response to the second information request due to the first user information being stored in the server in association with the second token, store the job information in the memory in association with the first user information, and
in a case where the first user information is not received from the server due to the first user information not being stored in the server in association with the second token, the job information is not stored in the memory.

12. The communication system according to claim 11, wherein
the first communication device is further configured to:
in a case where the first user information is not received from the server due to the first user information not being stored in the server in association with the second token, send a predetermined notification to the second communication device.

13. A non-transitory computer-readable recording medium storing computer-readable instructions for a first communication device, wherein
the first communication device comprises:
a memory configured to store job information for causing the first communication device to execute a job in association with first user information corresponding to a first user; and
a processor, wherein
the computer-readable instructions, when executed by the processor, cause the first communication device to:
in a case where a first user authentication for the first user corresponding to the first user information is successful in a server on the Internet, receive a first token from the server, the first token being created in response to success of the first user authentication and being stored in the server in association with the first user information;
send the server a first information request including the first token received from the server so as to receive the first user information stored in the server in association with the first token from the server as a response to the first information request; and
execute the job following the job information stored in the memory due to the first user information received from the server matching the first user information stored in the memory in
association with the job information.
